(19) United States
(12) Patent Application Publication
(10) Pub. No.: US 2017/0276984 A1
(43) Pub. Date: Sep. 28, 2017

(54) LIQUID CRYSTAL DISPLAY DEVICE AND MANUFACTURING METHOD THEREOF

(71) Applicant: Samsung Display Co., Ltd., Yongin-si (KR)

(72) Inventors: Ji Phyo HONG, Hwaseong-si (KR); Sung Yi KIM, Hwaseong-si (KR); Young Gu KIM, Yongin-si (KR); Hyun Ku AHN, Hwaseong-si (KR); Gi Hoon YANG, Ansan-si (KR); Ho LIM, Suwon-si (KR); Suk Kung CHEI, Suwon-si (KR)

(21) Appl. No.: 15/457,812

(22) Filed: Mar. 13, 2017

(30) Foreign Application Priority Data
Mar. 22, 2016 (KR) 10-2016-0034040

(51) Int. Cl. G02F 1/1368; G02F 1/1339; G02F 1/1362

(52) U.S. Cl. CPC G02F 1/1368; G02F 1/136286; G02F 1/136227; G02F 1/13394; G02F 1/136209; G02F 2201/123; G02F 2001/136222; G02F 2201/121; G02F 2001/136295

(57) ABSTRACT

A liquid crystal display device comprising: a first substrate; a first gate line which extends in a first direction; first and second data lines which extend in a second direction different from the first direction and are adjacent to each other; a first pixel which includes a first display area in which a first pixel electrode connected to the first data line is disposed, and a first circuit area in which a first gate electrode connected to the first gate line is disposed; a second pixel which includes a second display area in which a second pixel electrode connected to the second data line is disposed, and a second circuit area in which a second gate electrode connected to the second gate line is disposed; and an opaque conductive pattern which extends in the first direction so as to overlap the first circuit area and the second circuit area.

This application claims priority to and the benefit of Korean Patent Application No. 10-2016-0034040, filed on Mar. 22, 2017, which is hereby incorporated by reference for all purposes as if fully set forth herein.

### BACKGROUND

1. Field

The present inventive concept relates to a liquid crystal display device and a method of manufacturing the same.

2. Description of the Related Art

The significance of display devices is increasingly enlarged with the development of multimedia. In response thereto, various kinds of display devices such as a liquid crystal display (LCD) and an organic light emitting display (OLED) are used.

Among them, the liquid crystal display device is one of the flat panel display devices that are most widely used at present, and includes two substrates in which field generating electrodes such as pixel electrodes and common electrodes are formed, and a liquid crystal layer interposed therebetween. The liquid crystal display device displays an image, by applying a voltage to the field generating electrode to generate an electric field in a liquid crystal layer, by determining the direction of liquid crystal molecules of the liquid crystal layer through the electric field, and by controlling the polarization of the incident light.

### SUMMARY

An aspect of the present inventive concept provides a liquid crystal display device capable of improving characteristics of a switching element connected to a pixel electrode, and a manufacturing method thereof.

Further, another aspect of the present inventive concept provides a liquid crystal display device capable of reducing the number of mask processes for forming another black matrix by forming an opaque conductive pattern using an ink jet printing method, and a manufacturing method thereof.

The aspects of the present inventive concept are not limited to the aforementioned aspects, and other aspects which have not been mentioned will be clearly understood by those skilled in the art from the following description. According to the embodiments of the present inventive concept, a mask process for forming another black matrix may be omitted by forming an opaque conductive pattern using the inkjet printing method.

Further, because the opaque conductive pattern is disposed so as to overlap the gate electrode of the switching element, by reducing an amount of change in a threshold voltage value of the switching element, the characteristics of the switching element may be improved.

An exemplary embodiment of the present inventive concept discloses a liquid crystal display device comprising: a first substrate; a first gate line which extends on the first substrate in a first direction; first and second data lines which extend on the first gate line in a second direction different from the first direction and are adjacent to each other; a first pixel which includes a first display area in which a first pixel electrode connected to the first data line is disposed, and a first circuit area in which a first gate electrode connected to the first gate line is disposed; a second pixel which includes a second display area in which a second pixel electrode connected to the second data line is disposed, and a second circuit area in which a second gate electrode connected to the second gate line is disposed; and an opaque conductive pattern which extends in the first direction so as to overlap the first circuit area and the second circuit area.

An exemplary embodiment of the present inventive concept also discloses a liquid crystal display device comprising: a first substrate; a gate conductor which comprises a first gate line extending on the first substrate in a first direction; a data conductor which comprises a first data line and a second data line extending on the gate conductor in a second direction different from the first direction; and an opaque conductive pattern extending on the data conductor in the first direction. The opaque conductive pattern completely covers the gate conductor in a plan view.

An exemplary embodiment of the present inventive concept also discloses a method of manufacturing a liquid crystal display device, the method comprising: forming a gate line extending in a first direction on a first substrate; forming a data line extending in a second direction different from the first direction on the gate line; forming a first pixel electrode connected to the first data line on the data line; forming an opaque conductive pattern on the data line so as to be insulated from the first pixel electrode. The opaque conductive pattern may extend in the first direction so as to cover the gate line.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a layout diagram schematically illustrating first to fourth pixels according to an embodiment of the present inventive concept;

FIG. 2 is a cross-sectional view taken along a line I-I′ of FIG. 1;

FIG. 3 is a cross-sectional view taken along a line II-II′ of FIG. 1;

FIG. 4 is a cross-sectional view taken along a line III-III′ of FIG. 1;

FIG. 5 is a diagram for explaining a method of forming an opaque conductive pattern of the liquid crystal display device according to an embodiment of the present inventive concept;

FIG. 6 is a diagram for explaining a column spacer of the liquid crystal display device according to an embodiment of the present inventive concept;

FIG. 7 is a flowchart of a method of manufacturing the liquid crystal display device according to an embodiment of the present inventive concept; and

FIGS. 8 and 9 are cross-sectional views illustrating a method of manufacturing the liquid crystal display device according to an embodiment of the present inventive concept.

### DETAILED DESCRIPTION

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments will be described with reference to the accompanying drawings.

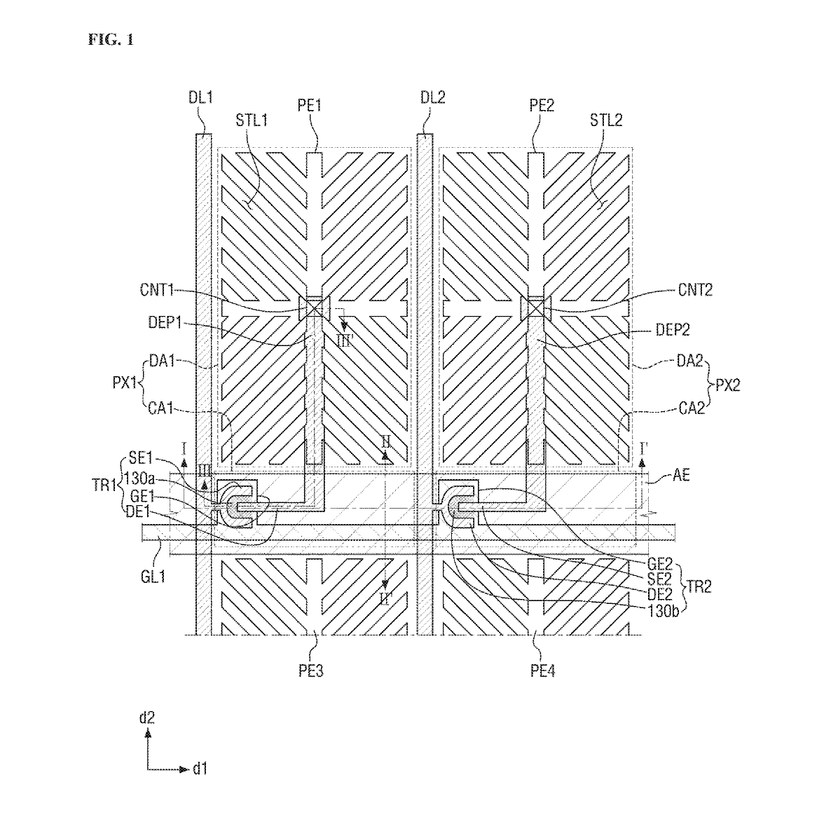

FIG. 1 is a layout diagram schematically illustrating first to fourth pixels of a liquid crystal display device according to an embodiment of the present inventive concept. However, the first to fourth pixels PX1 to PX4 will be described on the basis of first and second pixels PX1 and PX2, and the repeated description will be not be provided. Referring to FIG. 1, a first gate line GL1 extends in a first direction d1. A first data line DL1 and a second data line DL2 extend in a second direction d2. The first direction d1 may perpendicularly intersect with the second direction d2. In the present specification, the first direction d1 is illustrated as a row direction, and the second direction d2 is illustrated as a column direction.

The first and second data lines DL1 and DL2 are disposed to be adjacent to each other. In this specification, the expression “the two elements are disposed to be adjacent to each other” means that the same element as the two elements is not disposed between the two elements.

The first pixel PX1 may include a first display area DA1 and a first circuit area CA1. The first pixel PX1 may include a first pixel electrode PE1 disposed in the first display area DA1, and a first gate electrode GE1 disposed in the first circuit area CA1. On the other hand, the first pixel PX1 may further include a first switching element TR1 that is electrically connected to the first pixel electrode PE1 and has the first gate electrode GE1.

More specifically, the first switching element TR1 may be a three-terminal element such as a thin film transistor as an example. Hereinafter, an example in which the first switching element TR1 is a thin film transistor will be described. The first gate electrode GE1 of the first switching element TR1 may be connected to the first gate line GL1. One electrode of the first switching element TR1, for example, the first source electrode SE1 may be connected to the first data line DL1. The other electrode of the first switching element TR1, for example, the first drain electrode DE1 may be electrically connected to the first pixel electrode PE1.

As a result, the first switching element TR1 is turned on in accordance with the gate signal provided from the first gate line GL1 through the first gate electrode GE1, and may supply the data signal, which is provided from the first data line DL1 though the first source electrode SE1, to the first pixel electrode PE1 through the first drain electrode DE1 and a first contact hole CNT1 to be described later.

Here, the first gate electrode GE1 and the first source electrode SE1 of the first switching element TR1 may be disposed in the first circuit area CA1. On the other hand, the first drain electrode DE1 of the first switching element TR1 may be disposed in both of the first circuit area CA1 and the first display area DA1. However, the forms of the first source electrode SE1 and the first drain electrode DE1 are not limited to those illustrated in FIG. 1. That is, in the case where the first gate electrode GE1 is disposed in the first circuit area CA1 the positions of the first source electrode SE1 and the first drain electrode DE1 may vary.

The second pixel PX2 may include a second display area DA2 and a second circuit area CA2. The second pixel PX2 includes a second pixel electrode PE2 disposed in the second display area DA2, and a second gate electrode GE2 disposed in the second circuit area CA2. On the other hand, the second pixel PX2 may further include a second switching element TR2 that is electrically connected to the second pixel electrode PE2 and has the second gate electrode GE2.

The second switching element TR2 is turned on in accordance with the gate signal provided from the first gate line GL1 through the second gate electrode GE2, and may provide the data signal, which is provided from the second data line DL2 through the second source electrode SE2, to the second pixel electrode PE2 through the second drain electrode DE2 and a second contact hole CNT2 which will be described later.

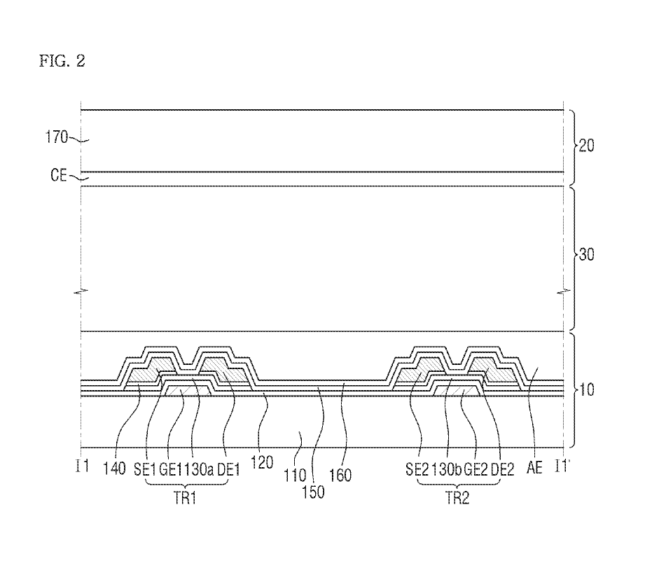

An opaque conductive pattern AE extends in the first direction d1 so as to overlap the first and second circuit areas CA1 and CA2. More specifically, the opaque conductive pattern AE may be disposed on the first gate line GL1, the first gate electrode GE1 and the second gate electrode GE2 (see FIG. 2). Meanwhile, the first gate line GL1, the first gate electrode GE1 and the second gate electrode GE2 may be collectively referred to as gate conductors. That is, the opaque conductive pattern AE may cover the gate conductor over the first and second circuit areas CA1 and CA2. The opaque conductive pattern AE may completely cover the gate conductor in the first and second circuit areas CA1 and CA2.

Although it is not illustrated in the drawings, the opaque conductive pattern AE may be formed so as to cover all of a plurality of gate lines extending in the first direction d1 and the gate electrodes connected thereto. The opaque conductive pattern AE may prevent light from being transmitted through a plurality of circuit areas including the first circuit area CA1 and the second circuit area CA2. That is, the opaque conductive pattern AE may perform the role of a black matrix BM.

The opaque conductive pattern AE is insulated from the plurality of pixel electrodes including the first and second pixel electrodes PE1 and PE2. Therefore, when the opaque conductive pattern AE is insulated from the plurality of pixel electrodes, the form, the shape, the width and the like of the opaque conductive pattern AE are not limited to those illustrated in FIG. 1.

Furthermore, the opaque conductive pattern AE may overlap the first source electrode SE1 and the second source electrode SE2, and may overlap at least a part of the first drain electrode DE1 and at least a part of the second drain electrode DE2.

On the other hand, the first contact hole CNT1 may be located in the first display area DA1. To this end, the first switching element TR1 may further include a first extension DEP1 extending from the first drain electrode DE1. The first extension DEP1 may at least partially overlap the first pixel electrode PE1. The first contact hole CNT1 may expose at least a part of the first pixel electrode PE1, and thus, the first pixel electrode PE1 may be electrically connected to the first extension DEP1 through the first contact hole CNT1. As a result, it is possible to prevent a light leakage which may occur when the first contact hole CNT1 is located in the first circuit area CA1.

The first contact hole CNT1 may be located at the center of the first pixel electrode PE1. However, in the case where the first contact hole CNT1 is located in the first circuit area CA1, the position of the first contact hole CNT1 is not limited to that illustrated in FIG. 1.

The second contact hole CNT2 may be located in the second display area DA2. To this end, the second switching element TR2 may further include a second extension DEP2 that extends from the second drain electrode DE2. The second extension DEP2 may at least partially overlap the second pixel electrode PE2. The second contact hole CNT2 may expose at least a part of the second pixel electrode PE2, and thus, the second pixel electrode PE2 may be electrically connected to the second extension DEP2 through the second contact hole CNT2.

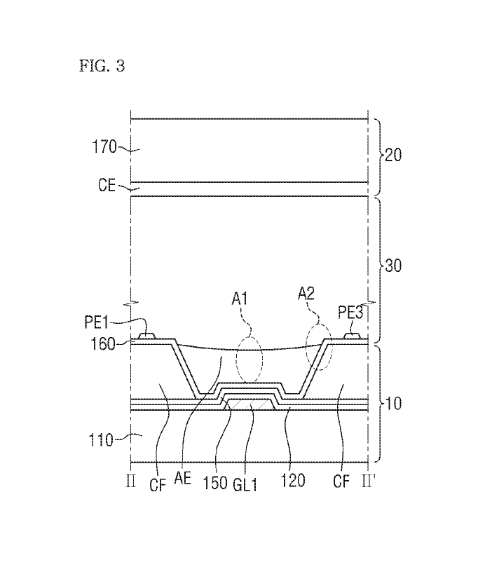

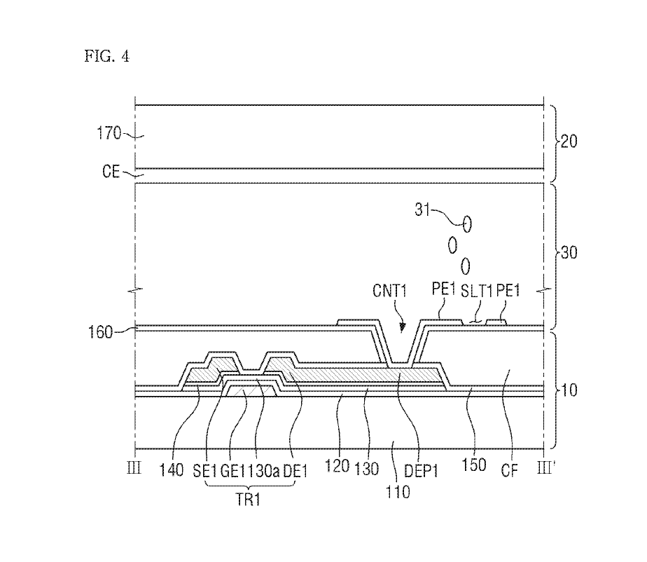

FIG. 2 is a cross-sectional view taken along the line I-I′ of FIG. 1. FIG. 3 is a cross-sectional view taken along the line II-II′ of FIG. 1. FIG. 4 is a cross-sectional view taken along the line III-III′ of FIG. 1.

The lower display panel 10 is attached to the upper display panel 20. The liquid crystal layer 30 is interposed between the lower display panel 10 and the upper display panel 20. That is, the lower display panel 10 and the upper panel 20 are disposed to face each other and may be attached to each other via sealant in an example.

First, the lower display panel 10 will be described.

The lower substrate 110 may be formed of a material having heat resistance and transparency. In an embodiment, the lower substrate 110 may be a transparent glass substrate, a plastic substrate or the like. The lower substrate 110 may be an array substrate on which the switching element TR is disposed. The first and second pixels PX1 and PX2 are disposed on the lower substrate 110.

The first gate line GL1, the first gate electrode GE1 and the second gate electrode GE2 may be disposed on the lower substrate 110. Each of the first and second gate electrodes GE1 and GE2 may protrude or expand from the first gate line GL1 toward a first semiconductor pattern 130a and a second semiconductor pattern 130b to be described later. As described above, the first gate line GL1, the first gate electrode GE1 and the second gate electrode GE2 may be collectively referred to as gate conductors.

In an embodiment, the gate conductor may be formed of a single film selected from a conductive metal including aluminum (Al), copper (Cu), molybdenum (Mo), chromium (Cr), titanium (Ti), tungsten (W), molybdenum tungsten (MoW), molybdenum titanium (MoTi) and copper/molybdenum titanium (Cu/MoTi), or the data conductor may be formed of a double film made of at least two elements thereof or a triple film made of at least three elements thereof.

A gate insulation film 120 may be disposed on the gate conductor. In an embodiment, the gate insulating film 120 may be formed of any one substance selected from an inorganic insulating material such as silicon oxide (SiOx) or silicon nitride (SiNx), or an organic insulating material such as benzocyclo bututene (BCB), an acrylic material and polyimide, or by mixing one or more substances. The gate insulating film 120 may have a multi-film structure including at least two insulating layers having different physical properties.

The first and second semiconductor patterns 130a and 130b may be disposed on the gate insulating film 120. The first and second semiconductor patterns 130a and 130b may have various shapes such as an island shape, a linear shape and the like. The first semiconductor pattern 130a, the first source electrode SE1 and the first drain electrode DE1 form the first switching element TR1. The second semiconductor pattern 130b, the second source electrode SE2 and the second drain electrode DE2 form the second switching element TR2.

In the case where the data conductor and the first and second semiconductor patterns 130a and 130b to be described later are formed together through the same process in the embodiment, the first and second semiconductor patterns 130a and 130b may be disposed below the data conductor. On the other hand, the first and second semiconductor patterns 130a and 130b may further include an area in which each channel of the first and second switching elements TR1 and TR2 is formed, in addition to the area disposed below the data conductor. That is, the semiconductor layer 130 including the first and second semiconductor patterns 130a and 130b may have substantially the same form as the data conductor, except for the area in which the channels of a plurality of switching elements including the first and second switching elements TR1 and TR2 are formed.

The semiconductor layer, 130a and 130b, may be formed of amorphous silicon, polycrystalline silicon or the like in an embodiment. In this case, an ohmic contact layer 140 may be disposed between the semiconductor layer, 130a and 130b, and the data conductor. The ohmic contact layer 140 may be made of a material such as n⁺ hydrogenated amorphous silicon doped with n-type impurities such as phosphorus at a high concentration or may be made of silicide.

Further, the semiconductor layer, 130a and 130b, may be made of one selected from an oxide semiconductor including In—Ga-Zinc-Oxide (IGZO), ZnO, ZnO2, CdO, SrO, SrO2, CaO, CaO2, MgO, MgO2, InO, In2O2, GaO, Ga2O, Ga2O3, SnO, SnO2, GeO, GeO2, PbO, Pb2O3, Pb3O4, TiO, TiO2, Ti2O3, and Ti3O5. In this case, the resistive contact layer 140 to be described later may be omitted.

The ohmic contact layer 140 may be disposed on the top of the semiconductor layer 130. The ohmic contact layer 140 may be made of a material such as n⁺ hydrogenated amorphous silicon doped with n-type impurities such as phosphorus at a high concentration, or may be made of silicide.

The first data line DL1, the second data line DL2, the first source electrode SE1, the first drain electrode DE1, the second source electrode SE2 and the second drain electrode DE2 may be collectively referred to as a data conductor. The data conductor may be disposed on the top of the semiconductor layer 130. The first source electrode SE1 of the first switching element TR1 may be connected to the first data line DL1, and may be disposed on the same layer, while being spaced from the first drain electrode DE1 at a predetermined distance. The second source electrode SE2 of the second switching element TR2 may be connected to the second data line DL2, and may be disposed on the same layer, while being spaced from the second drain electrode DE2 at a predetermined distance.

As described above, the first drain electrode DE1 may be connected to the first extension DEP1 extending from the first circuit area CA1. The first extension DEP1 extends so as to overlap at least a part of the first pixel electrode PE1, and may be electrically connected to the first pixel electrode PE1 through the first contact hole CNT1. The second drain electrode DE2 may be connected to a second extension DEP2 extending from the second circuit area CA2. The second extension DEP2 extends so as to overlap at least a part of the second pixel electrode PE2, and may be electrically connected to the second pixel electrode PE2 through the second contact hole CNT2.

On the other hand, the first extension DEP1 may overlap a stem section PE1a of the first pixel electrode PE1 in an embodiment. Further, the second extension DEP2 may overlap a stem section PE2a of the second pixel electrode in an embodiment. The data conductor may be formed of a single film selected from a conductive metal including aluminum (Al), copper (Cu), molybdenum (Mo), chromium (Cr), titanium (Ti), tungsten (W), molybdenum tungsten (MoW), molybdenum titanium (MoTi) and copper/molybdenum titanium (Cu/MoTi), or the data conductor may be formed of a double film made of at least two elements thereof or a triple film made of at least three elements thereof. However, the data conductor is not limited thereto, and may be made of several different metals or conductors.

The first passivation layer 150 may be disposed on the top of the data conductor and the gate insulating film 120. The first passivation film 150 has an opening which exposes a part of the first extension DEP1 of the first switching element TR1 and a part of the second extension DEP2 of the second switching element TR2. In an embodiment, the first passivation film 150 may be formed of an inorganic insulator such as silicon nitride and silicon oxide.

A color filter CF may be disposed on the first passivation film 150. The color filter CF may contain a photosensitive material. The color filter CF may include three color filter layers that display each of red, green, and blue in an embodiment. Each of the three color filter layers may be formed through mutually independent mask processes. On the other hand, the color filter CF may also function as an organic insulating film. Or, the color may further include an organic insulating film disposed on the color filter CF.

The second passivation film 160 may be disposed on the color filter CF. The second passivation film 160 may be formed of an inorganic insulating material such as silicon nitride and silicon oxide. The second passivation film 160 prevents the top of the color filter CF from peeling, and may prevent defects such as afterimages that may be caused when driving the screen, by suppressing the contamination of the liquid crystal layer 30 caused by organic material such as solvent out-diffused from the color filter CF.

The first and second pixel electrodes PE1 and PE2 may be disposed on the second passivation film 160. The first and second pixel electrodes PE1 and PE2 may be formed of a transparent conductive material such as indium tin oxide (ITO) or indium zinc oxide (IZO). The first pixel electrode PE1 may include a plurality of first slits SLT1. In addition, the second pixel electrode PE2 may include a plurality of second slits SLT2. The plurality of first and second slits SLT1 and SLT2 form a horizontal electric field between the first and second pixel electrodes PE1 and PE2 and a common electrode CE to be described later, such that the plurality of liquid crystal molecules 31 may rotate in a specific direction. On the other hand, the forms of the first and second pixel electrodes PE1 and PE2 are not limited to those illustrated in FIG. 1.

The first pixel electrode PE1 may be electrically connected to the first extension DEP1 of the first switching element TR1 through the first contact hole CNT1. Therefore, when the data signal is supplied to the first pixel electrode PE1 through the first data line DL1, a fringe filed is formed between the first pixel electrode PE1 and the common electrode CE to which the common voltage is supplied. Thus, a plurality of liquid crystal molecules 31 interposed between the lower display panel 10 and the upper display panel 20 rotate to achieve the gradation. Similarly, the second pixel electrode PE2 may be electrically connected to the second extension DEP2 of the second switching element TR2 through the second contact hole CNT2.

The opaque conductive pattern is formed on the second passivation film 160 in which color filter CF is not disposed below the second passivation film 160 as disclosed in FIG. 3.

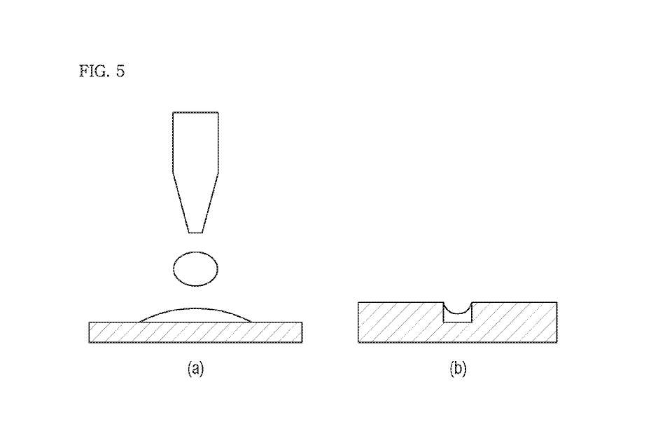

FIG. 5 is a diagram for explaining a method of forming an opaque conductive pattern of the liquid crystal display device according to an embodiment of the present inventive concept.

Referring to FIGS. 1 to 5, the opaque conductive pattern AE may be disposed on the second passivation film 160 so as to overlap the first and second circuit areas CA1 and CA2. The opaque conductive pattern AE may be formed so as to completely cover the above-mentioned gate conductor.

The opaque conductive pattern AE may contain chromium oxide (CrOx). In addition, the opaque conductive pattern AE may be made of a single film selected from a conductive metal including aluminum (Al), copper (Cu), molybdenum (Mo), chromium (Cr), titanium (Ti), tungsten (W), molybdenum tungsten (MoW), molybdenum titanium (MoTi) and copper/molybdenum titanium (Cu/MoTi), or the opaque conductive pattern AE may be formed of a double film made of at least two elements thereof or a triple film made of at least three elements thereof. On the other hand, when it is possible to prevent light from being transmitted through the first and second circuit areas CA1 and CA2, the material of the opaque conductive pattern AE is not limited to the aforementioned material. Thus, the opaque conductive pattern AE may prevent light from being transmitted through the first and second circuit areas CA1 and CA2. Further, a brightness of black gray level may be reduced by blocking of the light leakage by the opaque conductive pattern AE.

On the other hand, the opaque conductive pattern AE may extend along the first direction d1. More specifically, the opaque conductive pattern AE may extend along the first and second circuit areas CA1 and CA2 of each of the first and second pixels PX1 and PX2. That is, the opaque conductive pattern AE may be formed to continuously extend so as to cover the circuit areas of each of the adjacent pixels.

In an embodiment, the opaque conductive pattern AE is in a floating state or a DC voltage of 0 V may be applied. On the other hand, since the opaque conductive pattern AE overlaps each of the first and second gate electrodes GE1 and GE2, consequently, the first and second switching elements TR1 and TR2 have a double gate structure. As a result, when referring to Table 1 below, a variation range of the threshold voltage values of each of the first and second switching elements TR1 and TR2 may be reduced, thereby securing the stable switching characteristics. In particular, it may be seen that the variation range of the threshold voltage values is relatively small when a voltage of 0 V is applied to the opaque conductive pattern AE.

TABLE 1

| | Related art | Present inventive concept | |
|---|---|---|---|
| | (bottom | (top & bottom gate) | |
| TFT type | gate) | top = floating | top = 0 V |
| NBTS | −4.79 | −3.154 | −0.02 |
| PBTS | 0.72 | −0.37 | 0.24 |

Meanwhile, referring to FIG. 5, the opaque conductive pattern AE may be formed using an inkjet printing method. Thus, the number of mask processes for forming the opaque conductive pattern AE may be reduced. In an embodiment, the opaque conductive pattern AE may be formed by utilizing the general ink jet printing method illustrated in FIG. 5(a). In another embodiment, the opaque conductive pattern AE may be formed by utilizing a hybrid printing method illustrated in FIG. 5(b). The hybrid printing method refers to a technique having both advantages of a piezoelectric type ink jet printing method and an electrostatic type ink jet printing method. As a result, the opaque conductive pattern AE may be formed through more precise printing using the hybrid ink jet printing method, without being affected by the type of substrates. In an embodiment, referring to FIG. 3, when the opaque conductive pattern AE is formed through a hybrid inkjet printing method, the thickness of the central area A1 may be lower the thickness of the peripheral area A2.

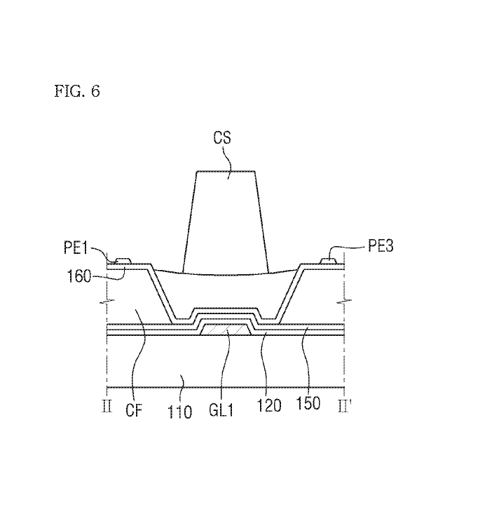

FIG. 6 is a diagram for explaining a column spacer in the configuration of the liquid crystal display device according to an embodiment of the present inventive concept.

Referring to FIGS. 2 to 4 and 6, the column spacer CS may be disposed on the opaque conductive pattern AE. The column spacer CS may have a tapered shape on both sides in a longitudinal direction in an embodiment, but is not limited thereto. That is, the column spacer CS may have a circular cross section in another embodiment.

Although it is not illustrated in the drawing, an alignment film may be disposed on the top of the first pixel electrode PE1, the second pixel electrode PE2 and the opaque conductive pattern AE. The alignment film may be formed of polyimide or the like. The alignment film may be formed over the entire surface of the pixel electrode PE.

Next, the upper display panel 20 will be described.

The upper substrate 170 may be disposed to face the lower substrate 110. The upper substrate 170 may be formed of transparent glass, plastic, or the like. That is, the upper substrate 170 may be formed of the same material as the lower substrate 110 in an embodiment.

A common electrode CE may be disposed on the upper substrate 170. The common electrode CE may be in the form of a plate in an embodiment, and may at least partially overlap a plurality of pixel electrodes including the first and second pixel electrodes PE1 and PE2. In an embodiment, the common electrode CE may be made of a transparent conductive material such as indium tin oxide (TO) and indium zinc oxide (IZO).

Although it is not illustrated in the drawing, an alignment film may be disposed on the common electrode CE of the upper substrate 170. The alignment film may be formed of polyimide or the like. The alignment film may be formed over the entire surface of the upper substrate 170.

That is, as the opaque conductive pattern AE is disposed on the lower substrate 110, more specifically, to overlap the first and second circuit areas CA1 and CA2, another black matrix BM is not disposed on the top of the upper substrate 170. In particular, since an opaque conductive pattern AE is formed through an inkjet printing process and a black matrix BM disposed on another upper substrate 170 is not required, it is possible to reduce the additional masking process for forming another black matrix BM on the upper substrate 170.

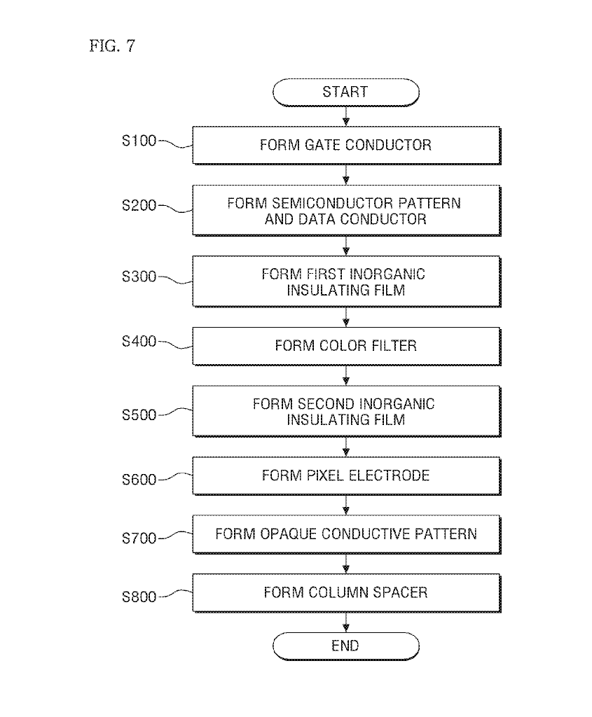

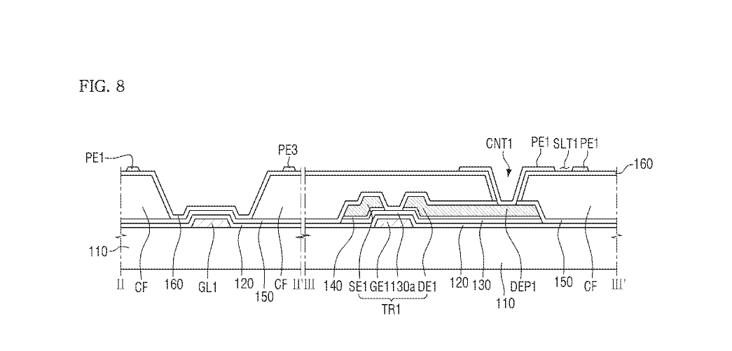

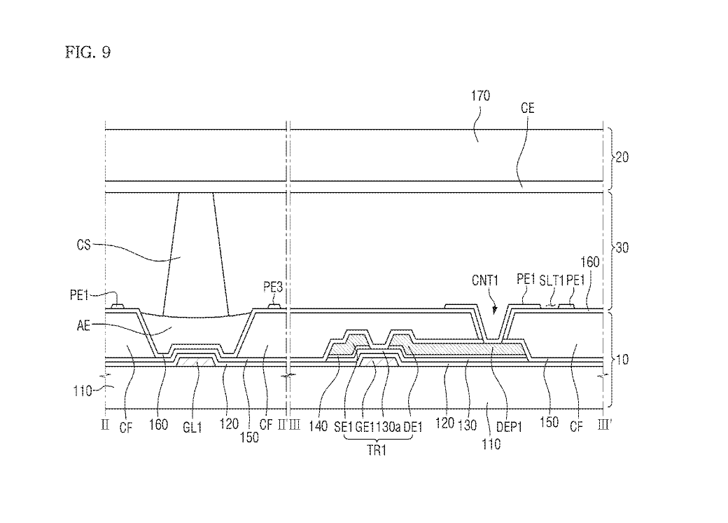

FIG. 7 is a flowchart of a method of manufacturing a liquid crystal display device according to an embodiment of the present inventive concept. FIGS. 8 and 9 are cross-sectional views illustrating the method of manufacturing the liquid crystal display device illustrated in FIG. 7 of the present inventive concept. For convenience of explanation, the description will be made based on a cross-sectional view taken along the line II-II′ and the line III-III′ of FIG. 1.

Referring to FIGS. 1, 3, 4, and 7 to 9, the gate conductor including the first gate line GL1, the first gate electrode GE1 and the second gate electrode GE2 is formed on the top of the lower substrate 110 (S100). The gate conductor may be formed of a single film selected from a conductive metal including aluminum (Al), copper (Cu), molybdenum (Mo), chromium (Cr), titanium (Ti), tungsten (W), molybdenum tungsten (MoW), molybdenum titanium (MoTi) and copper/molybdenum titanium (Cu/MoTi), or the gate conductor may be formed of a double film made of at least two elements thereof or a triple film made of at least three elements thereof.

Next, the gate insulating film 120 which covers the gate conductor is formed. The gate insulating film 120 may be formed of any one material selected from an inorganic insulating material such as silicon oxide (SiOx) or silicon nitride (SiNx), or an organic insulating material such as benzocyclo bututene (BCB), an acrylic material and polyimide, or by mixing one or more materials. The gate insulating film 120 may be formed by a chemical vapor deposition method in an embodiment.

Next, the first semiconductor layer 130a, the second semiconductor layer 130b and the data conductor may be formed on the gate insulating film 120 (S200). The first semiconductor layer 130a and the second semiconductor layer 130b may be formed by the same mask process as the data conductor which includes the first data line DL1, the second data line DL2, the first source electrode SE1, the first drain electrode DE1, the second source electrode SE2 and the second drain electrode DE2. Thus, the semiconductor layer 130a and 130b remains below the data conductor.

Next, a first inorganic insulating film 150 may be formed (S300). The first inorganic insulating film 150 may be formed on the data conductor. In an embodiment, the first passivation film 150 may be formed of an inorganic insulating material such as silicon nitride or silicon oxide.

Thereafter, a color filter CF may be formed on the first passivation film 150 (S400). Each of the three color filters may be formed through the mutually independent mask processes. Adjacent color filters may be spaced apart in the first and second circuit areas CA1 and CA2. Thus, the first inorganic insulating film 150 may have a recessed portion corresponding to the first and second circuit areas CA1 and CA2.

Next, a second passivation film (160) may be formed on the color filter CF (S500). In an embodiment, the second passivation film 160 may be formed of an inorganic insulating material such as silicon nitride or silicon oxide.

Thereafter, the first contact hole CNT1 and the second contact hole CNT2 may be formed through a photolithography process. More specifically, the first extension DEP1 and the second extension DEP2 may be at least partially exposed by etching the first and second inorganic insulating films on the first extension DEP1 and the second extension DEP2. The first and second passivation films 150 and 160 may be formed through this process.

Next, the first and second pixel electrodes PE1 and PE2 may be formed on the second passivation film 160 (S600). The first and second pixel electrodes PE1 and PE2 may include one that is selected from a group of transparent materials including indium tin oxide (ITO) and indium zinc oxide (IZO).

Thereafter, referring to FIG. 9, an opaque conductive pattern AE may be formed in the recessed portion using an inkjet printing method (S700). The opaque conductive pattern AE may be disposed on the second passivation film 160 and is insulated from the first and second pixel electrodes PE1 and PE2. On the other hand, by forming the opaque conductive pattern AE using an inkjet printing method without performing another mask process, the number of mask processes may be reduced.

However, the first and second pixel electrodes PE1 and PE2 forming process may be performed after the opaque conductive pattern AE forming process.

Thereafter, a column spacer CS is formed on the opaque conductive pattern AE (S800), and the lower substrate 110 and the upper substrate 170 may be attached to each other.

While the present inventive concept has been particularly illustrated and described with reference to exemplary embodiments thereof, it will be understood by those of ordinary skill in the art that various changes in form and detail may be made therein without departing from the spirit and scope of the present inventive concept as defined by the following claims. The exemplary embodiments should be considered in a descriptive sense only and not for purposes of limitation.

What is claimed is:

1. A liquid crystal display device comprising:
a first substrate;
a first gate line which extends on the first substrate in a first direction;
first and second data lines which extend on the first gate line in a second direction different from the first direction and are adjacent to each other;
a first pixel which includes a first display area in which a first pixel electrode connected to the first data line is disposed, and a first circuit area in which a first gate electrode connected to the first gate line is disposed;
a second pixel which includes a second display area in which a second pixel electrode connected to the second data line is disposed, and a second circuit area in which a second gate electrode connected to the second gate line is disposed; and
an opaque conductive pattern which extends in the first direction so as to overlap the first circuit area and the second circuit area.

2. The liquid crystal display device of claim 1, wherein the opaque conductive pattern completely covers the first gate line.

3. The liquid crystal display device of claim 1, further comprising:
a first switching element which has a gate electrode connected to the first gate line, one electrode connected to the first data line, and the other electrode connected to the first pixel electrode; and
a second switching element which has a gate electrode connected to the first gate line, one electrode connected to the second data line, and the other electrode connected to the second pixel electrode,
wherein the first switching element is disposed in the first pixel area and the second switching element is disposed in the second pixel region.

4. The liquid crystal display device of claim 3, wherein the first switching element is connected to the first pixel electrode through a first contact hole, and the second switching element is connected to the second pixel electrode through a second contact hole, and
wherein the first contact hole is disposed in the first display area and the second contact hole is disposed in the second display region.

5. The liquid crystal display device of claim 4, wherein the first contact hole is located at the center of the first pixel electrode, and the second contact hole is located at the center of the second pixel electrode.

6. The liquid crystal display device of claim 3, wherein the opaque conductive pattern overlaps a gate electrode of the first switching element and a gate electrode of the second switching element.

7. The liquid crystal display device of claim 3, wherein the first switching element further comprises a first extension which extends from the other electrode of the first switching element and overlaps the first pixel electrode, and
the second switching element further comprises a second extension which extends from the other electrode of the second switching element and overlaps the second pixel electrode.

8. The liquid crystal display device of claim 1, further comprising:
a gate insulating film disposed between the first and second data lines and the first gate line;
a first passivation film disposed on the first and second data lines;
a color filter disposed on the first passivation film; and
a second passivation film disposed on the color filter,
wherein the first pixel electrode, the second pixel electrode and the opaque conductive pattern are disposed on the second passivation film.

9. The liquid crystal display device of claim 1, further comprising:
a second substrate facing the first substrate; and
a common electrode disposed on the second substrate.

10. The liquid crystal display device of claim 1, further comprising:
a column spacer disposed on the opaque conductive pattern.

11. A liquid crystal display device comprising:
a first substrate;
a gate conductor which comprises a first gate line extending on the first substrate in a first direction;
a data conductor which comprises a first data line and a second data line extending on the gate conductor in a second direction different from the first direction; and
an opaque conductive pattern extending on the data conductor in the first direction,
wherein the opaque conductive pattern completely covers the gate conductor in a plan view.

12. The liquid crystal display device of claim 11, wherein the first substrate comprises:
a first pixel area which has a first display area in which a first pixel electrode connected to the first data line is disposed, and a first circuit area in which a first gate electrode connected to the first gate line is disposed; and
a second pixel area which has a second display area in which a second pixel electrode connected to the second data line is disposed, and a second circuit area in which a second gate electrode connected to the first gate line is disposed.

13. The liquid crystal display device of claim 12, wherein the opaque conductive pattern overlaps the first and second circuit areas.

14. The liquid crystal display device of claim 12, wherein the first pixel electrode is connected to the first data line through a first contact hole, and the second pixel electrode is connected to the second data line through a second contact hole, and
the first contact hole is disposed in the first display area, and the second contact hole is disposed in the second display region.

15. The liquid crystal display device of claim 11, further comprising:
a color filter disposed between the data conductor and the opaque conductive pattern.

16. The liquid crystal display device of claim 11, further comprising:
a column spacer disposed on the opaque conductive pattern.

17. A method of manufacturing a liquid crystal display device, the method comprising:
forming a gate line extending in a first direction on a first substrate;
forming a data line extending in a second direction different from the first direction on the gate line;
forming a first pixel electrode connected to the first data line on the data line;
forming an opaque conductive pattern on the data line so as to be insulated from the first pixel electrode,
wherein the opaque conductive pattern extends in the first direction so as to cover the gate line.

18. The method of claim 17, wherein the formation of the opaque conductive pattern comprises formation of the opaque conductive pattern using a hybrid printing method.

19. The method of claim 17, wherein the opaque conductive pattern comprise a central area, and a peripheral area located outside the central region, and
the height of the central area and the height of the peripheral area are different from each other.

20. The method of claim 17, further comprising:
forming a color filter disposed between the data line and the first pixel electrode after forming the data line.
